(19) United States
(12) Patent Application Publication
(10) Pub. No.: US 2013/0081776 A1
(43) Pub. Date: Apr. 4, 2013

(54) Methods For Forming Molded Components Having A Visible Designer Feature and/or Improved Operational Properties Via A Porous Preform

(71) Applicant: GM Global Technology Operations LLC, Detroit, MI (US)

(72) Inventors: Michael D. Hanna, West Bloomfield, MI (US); James A. Webster, Shelby Township, MI (US); Richard M. Kleber, Clarkston, MI (US)

(73) Assignee: GM GLOBAL TECHNOLOGY OPERATIONS LLC, Detroit, MI (US)

(21) Appl. No.: 13/689,840

(22) Filed: Nov. 30, 2012

Related U.S. Application Data
(62) Division of application No. 13/014,200, filed on Jan. 26, 2011.

(51) Int. Cl. F16D 65/12; B22D 25/02

(52) U.S. Cl. CPC F16D 65/12; B22D 25/02
USPC 164/112

(57) ABSTRACT

A method for forming a casted component using a porous structure. The casted component may include a visible design feature formed in part by the casted component and in part by a body material also forming other parts of the component. The casted component may be a brake rotor having a mixed-material composite formed in part by the casted component and in part by a body material also forming other parts of the rotor. The porous structure can include a ceramic foam or a metal mesh.

### TECHNICAL FIELD

The present disclosure relates generally to molded components and, more particularly, to molded components having at least one visible design feature, reduced weight, or increased strength via selective inclusion of a porous preform forming a mixed-material composite.

### BACKGROUND

Casted components, such as brake rotors, are often unmarked due to difficulty of marking. For components that will experience wear during use, effective marking is especially challenging or impossible to maintain. Regarding brake rotors, for example, a marking on a frictional surface including print, a label, or etching will quickly wear in response to a few applications of the breaks. In some cases, effective and lasting marking of the component is possible, but cost prohibitive or has negative effects on the component. An exemplary negative effect on the component is an unwanted increase in weight or unacceptable decrease in component strength or frictional properties.

Another challenge regarding many molded parts is achieving a desired balance between cost and performance characteristics such as weight and strength. To describe an example, cast-iron drum-in-hat brake rotors include a flat disc braking surface and an integral cylindrical braking surface for in a drum, or hat portion. The cylindrical friction surface, and so the rotor, would benefit from increased strength, lower mass, and improved performance characteristics (e.g., coefficient of friction and energy absorption), especially at a comparable or lower price than conventional rotors.

For molded parts such as rotors, weight and strength properties are important, even in connection with portions of the rotor that do not serve a frictional purpose. For example, a hat portion of the rotor configured for attaching the rotor to a wheel and the vehicle would benefit from being strengthened and lighter.

### SUMMARY

In one aspect, the present disclosure relates to a brake rotor having a visible design feature. The brake rotor includes a rotor body having a primary portion and a design portion. The primary portion consists of a metal, and the design portion consists of a composite of a porous structure, or insert, and the metal.

In another aspect, the present disclosure relates to a method for forming a brake rotor having a visible design feature. The method includes positioning a porous structure in a casting mold, the porous structure defining a three-dimensional area and introducing molten metal into the casting mold. From introducing the molten metal, the molten metal is introduced into the area of the porous structure for creating a design portion of the rotor, and occupies the mold adjacent the porous structure for creating a primary portion of the rotor.

In yet another aspect, the present disclosure further relates to a casted-metal component having a visible design feature. The casted-metal component includes a component body having a primary portion and a design portion. The primary portion consists of a metal and the design portion consists of a composite including a porous structure and the metal.

In still another aspect, the present disclosure relates to a brake rotor including a frictional disc and a hat portion connected to the frictional disc. The hat portion includes a hub portion and a frictional surface portion. The hub portion includes a body material, and the frictional surface portion includes a mixed-material comprising a porous structure substantially saturated with the body material.

In another aspect, a method for forming a brake rotor having a visible design feature is described. The method includes positioning a porous structure in a casting mold, the porous structure defining a three-dimensional area. The method also includes introducing molten metal into the casting mold so that the molten metal is introduced into the area of the porous structure for creating a mixed-material composite. The molten metal is also introduced to the area so that the metal occupies the mold adjacent the porous structure for creating other portions of the rotor.

In a particular aspect, positioning the porous structure in the casting mold includes positioning the structure in a portion of the mold corresponding to a cylindrical drum-in-hat frictional surface for forming the surface to include the mixed-material composite.

In another particular aspect, positioning the porous structure in the casting mold includes positioning the structure in a portion of the mold corresponding to a bolt area of a hat of the rotor for forming the hat to include the mixed-material composite.

In still another particular embodiment, positioning the porous structure in the casting mold includes positioning the structure in a portion of the mold corresponding to a rotor disc for forming the rotor disc to include the mixed-material composite.

In a further aspect, another type of brake rotor is disclosed. The brake rotor includes a frictional disc and a hat portion connected to the frictional disc. The hat portion includes a body material and a mixed-material composite having a porous structure substantially saturated with the body material. The mixed-material composite also is positioned in at least an area of the rotor adjacent bolt holes of the hat portion by which the rotor is connectable to a wheel of a vehicle.

In still another embodiment, a brake rotor for use in automobiles includes a frictional disc. The frictional disc includes a mixed-material composite comprising a porous structure substantially saturated with a body material.

Other aspects of the present invention will be in part apparent and in part pointed out hereinafter.

### DESCRIPTION OF THE DRAWINGS

FIG. 1 illustrates a plan view of a first exemplary porous structure for forming a visible design feature in a molded or casted component.

FIG. 2 illustrates a plan view of a second exemplary porous structure for forming a visible design feature in a molded or casted component.

FIG. 3 illustrates a partially cut-away plan view of an exemplary molded or casted component, being a casted brake rotor, having visible design features formed using the porous structure of FIG. 1 or FIG. 2.

FIG. 4 illustrates an exemplary method for forming a molded or casted component having the visible design feature, such as that shown in FIG. 3.

FIG. 5 illustrates an exemplary molded component, being a brake rotor and including a drum frictional surface having a mixed-material composite.

FIG. 6 illustrates a method for forming the mixed-material component of FIG. 5.

FIG. 7 illustrates a mold and select initial rotor parts used in the method of FIG. 6.

FIG. 8 illustrates an exemplary molded component, also being a brake rotor and including a hat portion having a mixed-material composite.

FIG. 9 illustrates a method for forming the mixed-material component of FIG. 8.

FIG. 10 illustrates a mold and select initial rotor parts used in the method of FIG. 9.

FIG. 11 illustrates a cross-sectional view of another exemplary molded component, being a brake rotor and including non-vented disc having a mixed-material composite reaching a frictional surface of the disc.

FIG. 12 illustrates a cross-sectional view of another exemplary molded component, being a brake rotor and including a non-vented disc having a mixed-material composite like that of FIG. 11, but without the composite reaching the frictional surface.

FIG. 13 illustrates a cross-sectional view of another exemplary molded component, being a brake rotor and including a vented disc having a mixed-material composite reaching a frictional surface of the disc.

FIG. 14 illustrates a cross-sectional view of another exemplary molded component, being a brake rotor and including a vented disc having a mixed-material composite that does not reach the frictional surface of the disc.

FIG. 15 illustrates another exemplary molded component similar to that described in connection with FIGS. 8-10, but showing only the mixed-material composite in the bolt face of the rotor drum.

FIG. 16 illustrates a cross-sectional view of the rotor of FIG. 15.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern. The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to employ the present disclosure.

Overview of the Disclosure

In various embodiments, the present disclosure describes a method for preparing molded components to have a unique design feature using a porous structure, or insert. In an exemplary scenario, a brake rotor (e.g., vehicle disc brake rotor) is manufactured to include a design feature by positioning at least one porous structure into a mold for the rotor before introducing molten metal into the mold. By the presence of the porous structure, a design feature visible at an exterior of the component will be formed.

In some embodiments, the present disclosure describes methods for selectively strengthening a molded or casted component by inserting a coated or uncoated preform into the mold prior to introduction of component material. In some embodiments, the insert is used to lower a resulting mass of the component without compromising strength of the component or adding undesirable costs. In a particular application, a method for casting disc brake rotors is described. The preform in some cases includes a porous ceramic material (e.g., ceramic foam) or a metal mesh.

In one particular embodiment, the preform is provided in a portion of a brake rotor mold corresponding to a frictional surface of the rotor. In another particular embodiment, the preform is provided in a hat portion of a brake rotor, where the rotor connects to a wheel and a balance of a vehicle. For instance, the preform can be provided adjacent bolt holes of the hat portion of the rotor.

First Exemplary Porous Structure

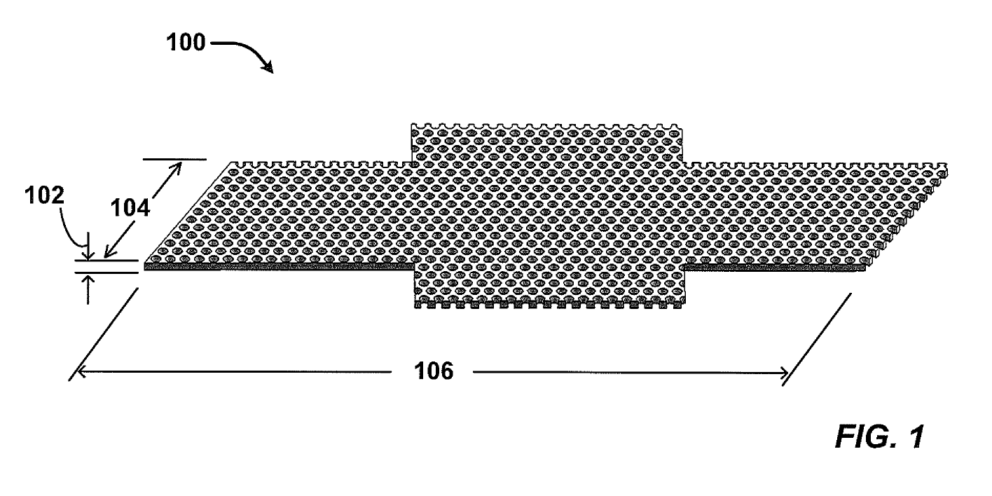

Now turning to the figures, and more particularly to the first figure, FIG. 1 illustrates a first exemplary porous preform or insert 100 for forming a design feature in a casted or molded component. The preform of insert 100 is referred to generally herein as a porous structure 100. The porous structure 100 can have any of a variety of configurations, including size, shape, and material, without departing from the scope of the present disclosure.

The design feature can be sized, shaped, and positioned in the mold to be visible before, and at least after machining the surface. In such case a height or thickness of the porous structure is less than the height of the corresponding portion of the mold. This approach may make any needed post casting machining easier and create tight tolerance.

In some cases, the material of the porous structure 100 is selected as a material that can withstand high-temperatures of a corresponding manufacturing process for the component, such as temperatures of molten metal in a cast-iron process. Withstanding the temperatures in some cases includes, for example, having physical properties that do not markedly change when exposed to the high-temperatures. In a contemplated embodiment, a satisfactory, or even preferred material for the porous structure 100 is one whose physical properties change to some extent, such as by partially melting, during the manufacturing process (e.g., when molten metal is introduced to the structure 100 for embodiments involving molten metal), such as to act as a bonding or transitional material.

Exemplary compositions for the porous structure 100 include foam, a fiber, or a mesh made of refractory, graphite or metals. The composition, or the porous structure, may be referred to as a matrix, as including a matrix, or more specifically a three-dimensional matrix. Regarding material, the porous structure is in some embodiments a ceramic foam, in some embodiments, a ceramic fiber matrix, and in some embodiments, a ceramic or metal mesh. The term matrix, as used herein, does not imply any particular shape or spacing between threads or other parts of the porous structure. For example, threads or other aspects of the matrix may, but need not, be equally spaced throughout the porous structure. The exemplary porous structure 100 in FIG. 1 includes ceramic and is in the form of a foam or fiber matrix.

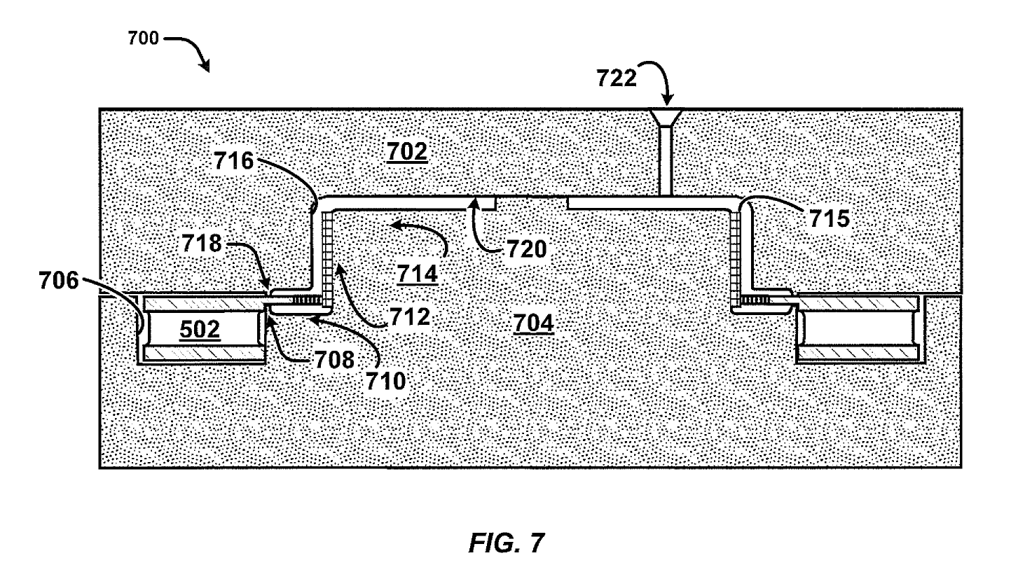

In some embodiments the porous structure is coated and cured. Coating the structure can be performed to achieve desired properties for the structure. In one contemplated embodiment, the porous structure is not completely coated. While the coating is not called out in the figures, the structure 715 as shown in FIG. 7 should be considered to show in its line thickness the coating for embodiments having the coating.

The desired properties resulting from coating relate to a desired interface between the porous structure/insert 100 and the material (e.g., molten metal) introduced into the mold, and thereby into the porous structure 100. Such interface might result in suppressing undesired vibration and noise of the component during use. These and other variables may be considered in designing the porous structure 100.

The coating may include any of a wide variety of materials without departing from the scope of the present invention. For instance, the coating may include refractory materials, graphite and binders. In some embodiments, the material of the coating can withstand high-temperatures of a corresponding manufacturing process, such as the temperatures of molten metal of a cast-iron process. In a contemplated embodiment, the material of the coating is selected to change to some extent, such as partially melting, during the process of introducing material (e.g., molten metal) to the porous structure.

The porous structure 100 is three-dimensional, including a height 102, a width 104, and a length 106. Dimensions (e.g., 102, 104, 106) are selected based on the needs of the designer. Accordingly, the porous structure 100 is said to define a three-dimensional area, which is particularly defined by a periphery or boundary of the structure 100.

Variables for selecting the dimensions include, in some embodiments, dimensional limitations of the component in which the porous structure 100 is to be included. For instance, it may be desired to size the porous structure 100 so that it has a dimension, such as height, that is only a certain percentage of a corresponding dimension of the component or a part of the component to be associated with the porous structure. For instance, in the brake rotor example, it may be desired to size the porous structure 100 so that the height 102 of the porous structure is not more than somewhere between about 5% and about 50% of a thickness of a rotor plate in which the porous structure is to be positioned during manufacturing of the rotor. The porous structure can be positioned and secured in a cavity of the casting mold cavity in a variety of ways, including using chaplets, spacers, or suspending the structure in the mold cavity by other means.

In one embodiment, it may be desired for the design feature to extend from a first surface of the component, or part thereof through to a second surface of the component, or part thereof. Continuing with the rotor example, then, it would be desired that the height 102 of the porous structure be about 100% of a thickness of the rotor plate when the surface is machined to the desired dimension, creating a channel through the component/part, such as for improved heat dissipation or distribution, and allowing the display feature to be visible on multiple surface of the component.

In another example, the design feature formed by the porous structure/insert can also be visible after machining the surface. In such case, as provided above, the height or thickness of the porous insert is less than a height of the casted component, and any needed post casting machining may be easier and the resulting component can have a tighter tolerance compared to conventional processes.

Second Exemplary Porous Structure

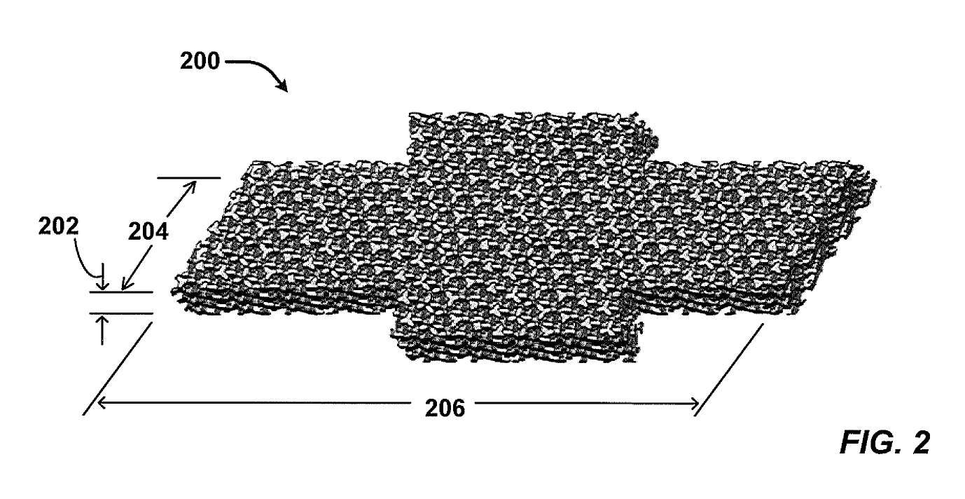

FIG. 2 illustrates a porous structure 200 in accordance with another embodiment of the present disclosure. As with the porous structure 100 of FIG. 1, the porous structure 200 shown in FIG. 2 is three-dimensional, having a height 202, a width 204, and a length 206. Accordingly, the porous structure 200 is said to define a three-dimensional area, which is particularly defined by a periphery or boundary of the structure 200. And, again, the dimensions (e.g., 202, 204, 206) are selected based on the needs of the designer, such as by being based on one or more dimensions of the component to be formed to include the structure 200.

The porous structure 200 shown in FIG. 2 is shown for illustrative purposes as a mesh, such as a metal mesh, but can have any porous form. The porous structure 200 described in connection with FIG. 2 otherwise has the features described above with respect to the porous structure 100 of FIG. 1.

Exemplary Component Having Design Feature

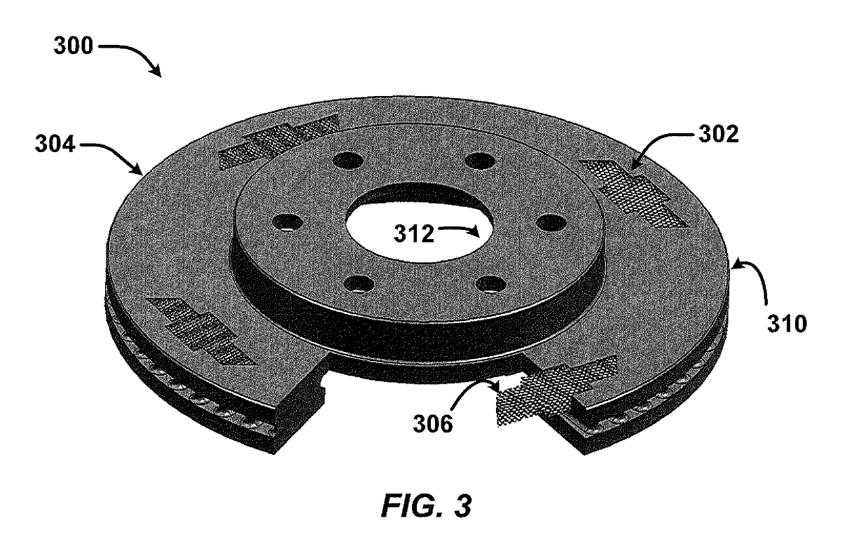

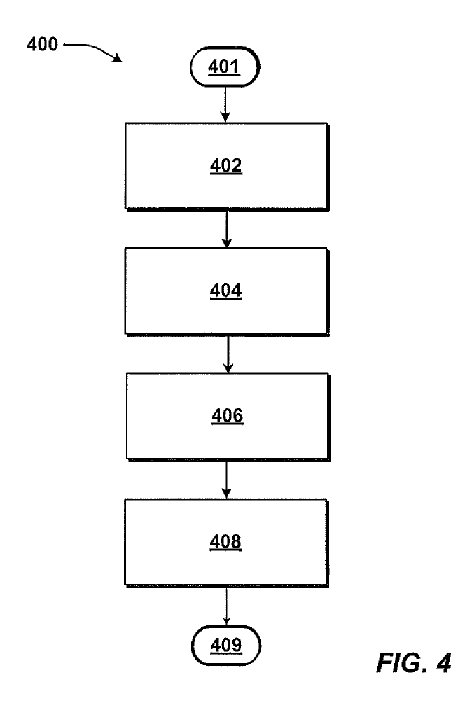

FIG. 3 illustrates an exemplary casted component 300, specifically a cast-iron disc brake rotor for use in an automobile. The component 300 in FIG. 3 is the resulting component, having the design feature 302 formed by inclusion of a porous structure (e.g., the porous structure 100 or 200, described above) into a casting mold before the molten metal to form the rotor 300 is introduced to the mold. The process for creating the component 300 having the design feature is described in further detail below in connection with FIG. 4.

As shown in FIG. 3, the design feature 302 extends to adjacent a primary surface 304 of the component 300. Particularly, the design feature 302 includes a surface 306 that ends up adjacent the surface 304 of the component 300. In this rotor example, it will be appreciated that the primary surface 306 of the rotor 300 is a frictional surface to be contacted by a rotor pad (not shown) in operation of the rotor.

In some embodiments, the two surfaces 304, 306 are generally aligned with each one another, such as by being generally flush or coplanar. In one contemplated embodiment, the porous structure 100, 200 is sized, shaped, and arranged in the mold so that the surface of the design feature is spaced from the surface of the adjacent surface of the primary portion of the component. In any event, the design feature 302 formed by the porous structure 100, 200 is visible to an observer of the finished component 300.

As provided above and further below, the porous material 100, 200 is in some embodiments partially or completely coated. Coating the structure can be done to obtain desired properties for the structure, such as an interface for Coulomb damping of vibration and noise. The coating may include any of a wide variety of materials without departing from the scope of the present invention. For instance, the coating may include refractory materials, graphite and binder.

In some embodiments, the material of the coating can withstand high temperatures of a corresponding manufacturing process, such as a cast-iron molten metal process. In a contemplated embodiment, the material of the coating is selected to change to some extent, such as partially melting, during the process of introducing material (e.g., molten metal) to the porous structure.

It will be appreciated that the resulting component 300 can be said to include a design portion 308 and a primary portion 310 including the components outside of the design portion 308. More particularly, the design portion 308 includes the porous structure and the material embedded or otherwise introduced into it, and ending up within the periphery or boundary of the porous structure 100, 200.

The component 300 could also include segments that are formed of a material other than the material used to form the design features 302 a part of the component surrounding the design features 302. This additional segment can be considered as a part of the primary portion 310 of the component 300 or an additional portion. As an example of such a segment, having a different material, a hat segment 312 of the rotor 300 could be formed of aluminum (AL) while the design feature 302 and rotor surrounding the design feature 302 and forming the frictional surface, are formed of another material such as cast iron.

The body of the porous structure (e.g., metal mesh or ceramic foam/fiber) is designed in such a way that the structure has a balanced geographic imprint in relation to a rotor pad, which will contact the surface during operation, to enable equal wear and friction characteristics. It is expected that a wear resistance and brake output will be improved and a friction coefficient will increase. These improved performance qualities result from high wear resistance properties of refratories or ceramic used.

Method for Forming a Molded Component Having a Design Feature

FIG. 4 shows an exemplary method 400 for forming a brake rotor having a visible design feature, such as the brake rotor 300 of FIG. 3, according to an embodiment of the present disclosure. It should be understood that the steps of the method 400 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the illustrated method 400 can be ended at any time.

The method 400 begins 401 and flow proceeds to block 402, whereat a generally porous structure is formed. In some cases, the formed porous structure is like one or both of the exemplary porous structures 100, 200 shown and described in connection with FIGS. 1 and 2.

The porous structure may include any of a variety of configurations, including size, shape, and materials. Regarding shape, for example, the porous structure is in some embodiments shaped to form a design feature having at least one letter and in some cases one or more words. In some embodiments, the porous structure is shaped to form an emblem such as a trademarked logo of a company.

In one embodiment, the porous structure includes ceramic. In some embodiments, the porous structure defines a three-dimensional area having a height (e.g., height 102, 202), width, and length. Exemplary measurements are described above in connection with the structures 100, 200 shown in FIGS. 1 and 2.

In some cases, the material of the porous structure is selected to be a material that can withstand the high-temperatures of the corresponding manufacturing process, such as cast-iron molding. Withstanding the temperatures includes, for example, being exposed to the high-temperatures without changing or materially changing in any of physical properties, size, shape, material properties, or other. In a contemplated embodiment, a satisfactory, or even preferred material for the porous structure is one that does change to some extent, such as partially melting, during the manufacturing process (e.g., when molten metal is introduced to the structure for embodiments involving molten metal).

Exemplary make up of the porous structure include a foam, a fiber, or a mesh. These or other compositions may be referred to as a matrix, or in some cases a three-dimensional matrix. Regarding material, the porous structure is in some embodiments a ceramic foam, in some embodiments, a ceramic fiber matrix, and in some embodiments, a ceramic or metal mesh.

As provided, in some embodiments the porous structure is partially or completely coated. Coating the structure can be done to obtain desired properties for the structure, such as porosity. The coating may include any of a wide variety of materials without departing from the scope of the present invention. For instance, the coating may include cast iron, another iron alloy, or ceramic.

In one embodiment, the material of the coating can withstand high-temperatures of the corresponding manufacturing process. In a contemplated embodiment, the material of the coating is selected to change to some extent, such as partially melting, during the process of introducing the molten metal to the porous structure.

In one embodiment, the porous structure is pre-coated, and so coating it is not an express part of the method 400. The porous structure can also be cured to ensure or at least facilitate adherence of the coating material to a primary body of the porous structure.

At step 404, the porous structure is positioned in a casting mold (not shown). In some embodiments, the casting mold is a conventional casting mold. In other embodiments, the casting mold used is customized to accommodate inclusion of the design feature (e.g., design feature 302 of the component 300 described above in connection with FIG. 3) into the component.

The porous structure in this embodiment can also be positioned in the mold cavity in any of a variety of ways including by chaplets, spacers or by being suspended by tabs supported in the mold.

As provided, the resulting component (e.g., rotor) is in some embodiments manufactured to include multiple design features. The multiple design features may be the same, different, and arranged on or in the component in any of a variety of ways. For example, in some embodiments, the porous structures are identical and equally spaced about the component, such as shown in FIG. 3 with respect to the four generally equally spaced emblems. In other cases, porous structures are positioned about the component to form a pattern. In most of the present description, a single porous structure, and so single design features, is described for teaching purposes and is not meant to be limiting.

At step 406, material for forming the component is introduced (e.g., poured or injected) into the mold. The material is generally non-solid at this stage, and depending on the application may be molten, liquid, semi-solid, gelatinous, etc. For the cast-iron example, the material introduced is molten iron alloy.

When introduced to the mold, the material begins to fill the mold and is thereby introduced to the one or more porous structures therein. For instance, in the cast-iron example involving metal mesh, in step 406, the molten iron fills spaces between the parts (e.g., threads) of the porous structure. The material also fills a balance of the mold, other than the three-dimensional area associated with the porous structure. In this way, the porous structure, now much less porous and perhaps having no porosity at this point, is made integral with the balance of the component (e.g., rotor body). As provided, the portion of the component including the porous structure may be referred to as a design portion. The balance of the component may be referred to as a primary portion.

The previous steps, including forming a porous structure (e.g., size, shape) (step 402) and positioning the porous structure in the mold (step 404), are performed so that a surface (e.g. surface 306) of the resulting design features is positioned adjacent a surface (e.g., rotor frictional surface 304) of the primary portion of the component. In some embodiments, the two surfaces are generally aligned with each one another, such as by being generally flush or coplanar. In one contemplated embodiment, the porous structure is sized, shaped, and arranged in the mold so that the surface of the design feature is spaced from the surface of the adjacent surface of the primary portion of the component.

At step 408, the material (e.g., molten metal) is allowed to change to its solid form, such as by cooling or curing. The product of the method 400 is a completed customized component having at least one design feature that is visible on the component, such as the component 300 shown in FIG. 3. The method may end 409.

First Exemplary Mixed-Material Component

As provided above, inserts or preforms such as porous structures are in some embodiments of the present disclosure provided in a portion of a mold for reducing weight and/or adding strength to the resulting component. Alternatively, or in combination with the improved weight and strength, the resulting component in some embodiments also exhibits improved performance characteristics. As a particular example, a brake rotor is described. More specifically, a porous structure is introduced into a mold for forming the brake rotor at an area of the mold corresponding to a frictional surface of the rotor.

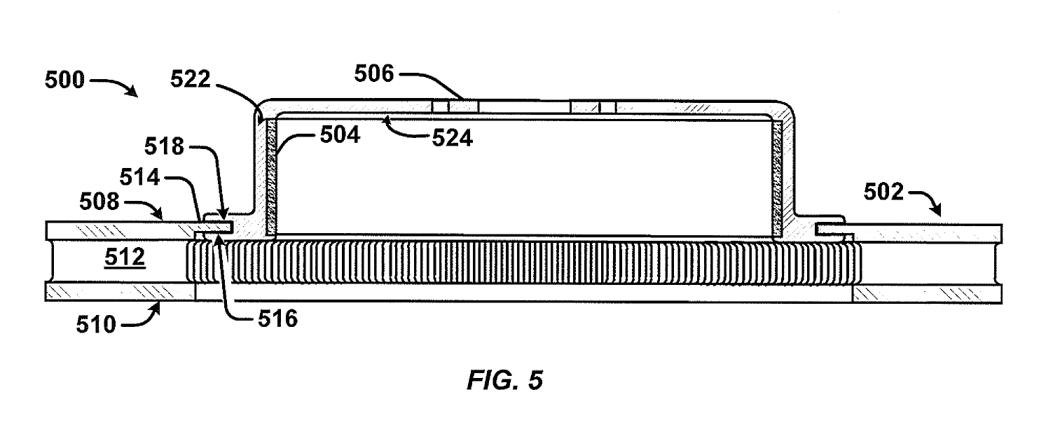

With further reference to the figures, FIG. 5 shows a cross-sectional view of a cast-in-place mixed-material drum-in-hat brake rotor 500.

While a rotor is described for teaching purposes, it will be appreciated that the technology of the present disclosure can be used to improve the design and performance of a wide variety of products. In this way, references to rotors, and the parts thereof, encompass other molded components and parts thereof, such as other types of rotors and other automobile components, as well as non-rotor and non-automobile components. The analogous nature of the disclosure also applies in cases in which parts do not correspond with parts of the exemplary rotor. For example, other components that can benefit from the present technology may not include a frictional surface in which the porous structure is provided, but will include other portions in which the porous structure can be provided. In an exemplary alternative embodiment, the present technology is used in an external surface of a contracting band positioned over a cylindrical-type brake, or of a surface of another type of brake, instead of in connection with a cylindrical frictional surface 504 of a hat 506 in the expanding hat-in-drum type of brake 500 illustrated in FIG. 5.

As shown in FIG. 5, the rotor 500 includes a frictional disc 502 and a cylindrical frictional surface 504 of a hub 506. The rotor 500 is configured so that the rotor disc 502, the cylindrical frictional surface 504, and the hub 506 are secured into a singular structure.

As shown in FIG. 5, the frictional disc 502 has an outboard frictional cheek or surface 508 and an inboard frictional cheek or surface 510. References to inboard and outboard indicate perspective with respect to a body or center of a vehicle such as an automobile comprising the rotor 500.

The outboard surface 508 of the frictional disc 502 is separated from the inboard surface 510 by a series of connecting vanes 512. The vanes 512 structurally connect the inboard surface 510 and the outboard surface 512 and facilitate cooling of the rotor disc 502. In one embodiment (not shown in detail), the rotor 500 includes a single disc having the inboard and outboard frictional surfaces, and so no vanes.

The frictional disc 502 includes a flange 514 having an inboard surface 516 and an outboard surface 518. The flange 514 is configured to facilitate transfer of torque from the disc 502 to the hub 506. The hub 506 also includes a flange 520 sized and shaped to receive the flange 514 of the frictional disc 502.

The components of the rotor 500 may comprise any of a variety of materials or combinations of materials without departing from the scope of the present technology. For instance, the frictional disc 502 in one embodiment includes steel, cast-iron, or a combination of these. As another example, the hub 506 may include an aluminum alloy, such as Al—Fe or an Al 356 casting alloy with a high silicon content.

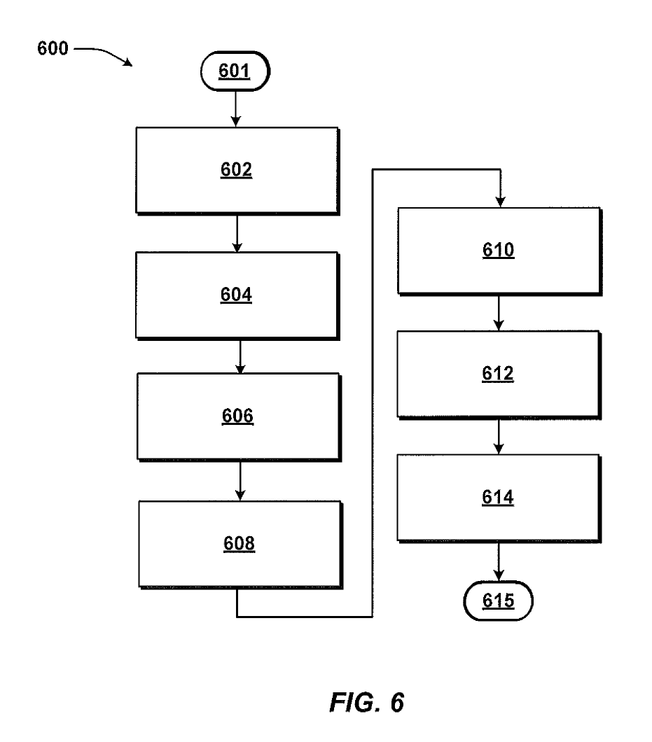

The cylindrical frictional surface 504 includes at least one porous structure (also referred to as a preform or insert). The porous structure is identified by reference numeral 715 in FIG. 7. As described in more detail below, in connection with the method 600 corresponding to FIG. 6, the composite frictional surface 504 is formed by positioning the porous structure 715 in a rotor mold prior to introduction of molten rotor material (e.g., aluminum) so that the molten material at least partially surrounds and is introduced into, or impregnates, the porous structure 715.

The porous structure 715 may be sized and shaped in any of a variety of ways, and include any of a variety of materials, without departing from the scope of the present technology. The porous structure 715 has a generally cylindrical profile, in the example of FIG. 7, corresponding to a shape of the interior of the rotor 500 and particularly the resulting cylindrical frictional surface 504 thereof. The porous structure 715 can be sized and shaped to constitute any portion, or percentage, of the resulting surface 504. In one embodiment, the porous structure is sized and shaped substantially the same as the resulting surface 504, and so reaches the surface and all sides of the surface 504.

Regarding composition, in one embodiment, the porous structure 715 includes silicon fibers, a highly-porous ceramic material, or a ferrous metal or metallic mesh. The porous structure 715 is in some embodiments partially or completely coated. As with previous embodiments, coating the structure 715 of this embodiment can be performed to achieve desired properties for the structure, such as an interface for Coulomb damping of vibration and noise. While the coating is not called out in the figures, the structure 715 as shown in FIG. 7 should be considered to show in its line thickness the coating for embodiments having the coating.

The coating may include any of a wide variety of materials without departing from the scope of the present technology. For instance, the coating may include one or more of a refractory material, graphite, and binder. In some embodiments, the material of the coating is selected to withstand high temperatures of a corresponding manufacturing process, such as a cast-iron molten metal process. In a contemplated embodiment, the material of the coating is selected to change to some extent, such as by partially melting, during the process of introducing material (e.g., molten metal) to the porous structure.

In some embodiments, the cylindrical frictional surface 504 includes aluminum, steel, cast iron, or titanium, or any combination of these or related alloys. In some embodiments, an outside diameter 520 of the cylindrical frictional surface 504 is specially configured to ensure desired interaction (e.g., torsional interlock) with the hub 506. The special configuration including, for example, a pattern such as an axial serration or spline, may be especially advantageous in cases in which the cylindrical frictional surface 504 comprises alternative materials such as steel, cast iron, or titanium while the hub 506 includes aluminum. The resulting surface 504 may be referred to as a metal matrix, mixed-material matrix, mixed-material composite, metal matrix composite, or the like.

First Exemplary Method for Forming Mixed-Material Brake Rotor

FIG. 6 schematically illustrates a method for forming the molded component 500 of FIG. 5, according to an embodiment of the present disclosure. It should be understood that the steps of the method 600 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the illustrated method 600 can be performed in parts, and so can be ended at any time.

The method 600 of FIG. 6 is described in connection with a mold 700 shown in FIG. 7. The method 600 begins 601 and flow proceeds to block 602, whereat the proper mold 700 is provided. The method 600 in various embodiments could include permanent molding, semi-permanent molding, die casting, enhanced die casting involving vacuum or pressurization, squeeze casting, subliquidus casting, powder metallurgy, semi-solid forgings, combinations of these, or other molding process.

The mold 700 includes two primary portions (e.g., halves), an upper mold portion 702 and a lower mold portion 704. Though the portions 702, 704 of the mold 700 are illustrated as being singular, one or both of them may include sub-parts connected to form the portions 702, 704. And though features associated with the present technology are at times referred to in a directional manner (e.g., upper, lower, height, width), with respect to all embodiments herein, the references are used for illustrative purposes only and are not to be limiting. For example, while parts of the mold are described as upper and lower portions, and shown as such, the mold could instead include laterally facing portions, etc.

With further reference to FIG. 6, at block 602 the mold 700 may be maintained within a controlled temperature range specific to the process used to achieve a proper state of thermal expansion of the mold 700. In some embodiments, temperatures of the frictional disc 502 and cylindrical frictional surface 504, including the porous structure, are also controlled before, at, and/or following a time of the placement to achieve a proper state of thermal expansion for the parts, and thereby ensuring proper fit of the parts in the mold 700.

At block 604, the frictional disc 502 and porous structure 715 are introduced into the mold 700. Regarding the frictional disc 502, the disc is positioned in an annular pocket 706 of the mold 700, the pocket being sized and shaped to receive the disc 502. FIG. 7 shows the disc 502 and porous structure 715 in place.

The mold 700 has various features configured to properly align the frictional disc 502 and the porous structure 715 in the mold 700. For example, the pocket 706 has an annular sealing ring 708 that locates the disc 502 in a precise position in the mold 700. To control lateral positioning of the disc 502, an outer diameter of the sealing ring is machined to a highly-controlled diameter that registers with a step of the disc 502, the step being associated with the disc flange 514. A top surface of the ring is machined to a highly-controlled height to register with the inboard surface 516 of the frictional disc flange 514 to precisely control a height of the frictional disc 502 in the mold 700.

Also for positioning the disc 502, the lower portion 704 of the mold 700 includes an annular flange profile 710 defining a molding surface for the inboard surface 516 of the frictional disc flange 514. Closer to a center of the mold 700, the lower mold portion 704 has a raised cylindrical surface 712 defining an inboard surface 522 (shown in FIG. 5) of the aluminum hub 506. The outside diameter of the raised cylindrical surface 712 is machined to a highly-controlled diameter that registers an inside diameter of the cylindrical frictional surface 504.

Moreover, a center portion 714 of the lower mold portion 704 defines an axle mounting surface 524 (shown in FIG. 5) of the hub 506. It will be appreciated that any of the positioning features described may be configured to allow for production of extra material on the casted product to arrive at a specific desired component size post finish machining.

Proper positioning of the porous structure 715 in the mold helps ensure that the finished friction surface is consistent in frictional properties. It is contemplated that, as provided above regarding positioning porous structures in other embodiments, the porous structure 715 of this embodiment can also be positioned in the mold 700 in ways such as by chaplets or spacers, or by being suspended by tabs supported in the mold 700.

The porous structure 715 in some embodiments has one or more feet, pads, or other extended or protruding base or segment (not shown in detail) to sit on a top of a surface of the mold 700 or other part, such as the male cylindrical surface 714 and/or the adjacent surface (of the flange 710) of the lower mold half 704 to suspend the porous structure 1000 at a proper height in the mold 700. In one contemplated embodiment, the structure 1000 and/or extended segment are sized to be larger than a height of the final void in the mold 700 (prior to introduction of filler material) so that closure of the mold 700 would crush the feet, bringing the porous structure 1000 to proper height.

In a contemplated embodiment, the cylindrical porous insert 715 fits closely over the male form of the lower portion 704 of the mold 700 to control its concentric position. In some embodiments, radial orientation is not needed because the same filler material is being used around the entire annular form on the side of the pocket 716 (shown in FIG. 7), corresponding to a resulting inboard surface 522 of the aluminum hub 506 (shown in FIG. 5).

In one contemplated embodiment, the cylindrical male surface 714 of the mold over which the insert 715 is placed to register its axial position in the mold has a height (or top) controlled by a length tolerance of the insert 714.

The upper mold portion 702 has a pocket 716 providing clearance for the frictional disc 502 when the mold is assembled. An inside edge of the pocket 716 of the upper mold portion 702 has an annular sealing ring 718. A bottom surface of the sealing ring 718 is machined to a highly-controlled height and rests on the upper surface 518 of the frictional disc flange 514. The annular sealing ring 718 of the upper mold 704 may be generally aligned with the annular sealing ring 708 of the lower mold portion 702 when the mold 700 is closed. A surface 720 of the upper mold portion 702 within the sealing ring 718 define an outboard shape of the rotor hub 606.

Continuing with reference to FIG. 6, at block 606, after the frictional disc 502 and porous structure 715 are positioned in the mold 700, as shown in FIG. 7, the mold is closed. In some embodiments, closing the mold 700 includes applying a closing or clamping force. The clamping force is resolved through the sealing rings 708, 718 and the inboard flange 514 of the frictional disc 502 to seal the mold 700 and contain the molten aluminum to follow.

At block 608, with the mold 700 closed, fluid filler material, such as molten aluminum or aluminum alloy, is introduced to the interior of the mold to for forming the hub 702 and to complete the cylindrical frictional surface 504. Particularly, the filler material fills the cavity formed between the mold portions 702, 704, thereby coating the rotor disc 502 and the porous structure 715. Due to the porosity of the porous structure, the filler material also impregnates the porous structure, so as to substantially saturate the structure, thereby forming a metal matrix composite to be the cylindrical frictional surface 504. The filler material may be introduced into the mold by any type of casting process, such gravity or pressure casting.

The filler material may is introduced into the mold cavity through, for instance, a gate opening 722 in the mold, which is shown as a component of the upper mold portion 702 for illustrative purposes. Actual placement and design of the gating for material introduction and venting and required shrinkage risers would be specific to the mold and molding process being used.

Block 610 represents a period of solidification in which the molten or otherwise fluid material solidifies. Following solidification, at block 612 the mold is opened and the molded rotor 500 removed. At block 614 the rotor 500 is finished as desired. At block 615, the process may end, and may be repeated to produce another rotor 500.

Second Exemplary Mixed-Material Component

As also provided in the Overview, above, another case in which inserts or preforms, such as porous structures, are introduced into a portion of a mold for improving weight, strength, and performance of the resulting component includes the structure being provided in a hat area of a brake rotor. The hat area is the area of the rotor at which the rotor connects to a wheel and balance of a vehicle (wheel and balance of the vehicle are not illustrated).

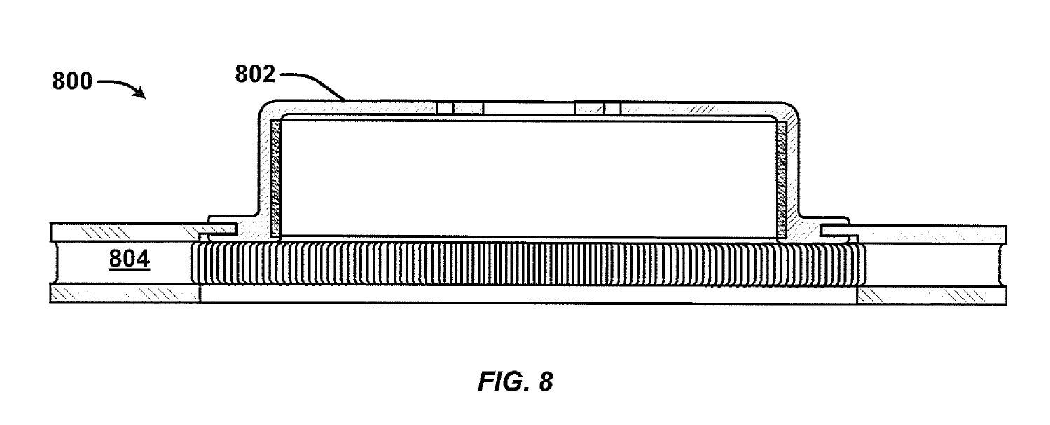

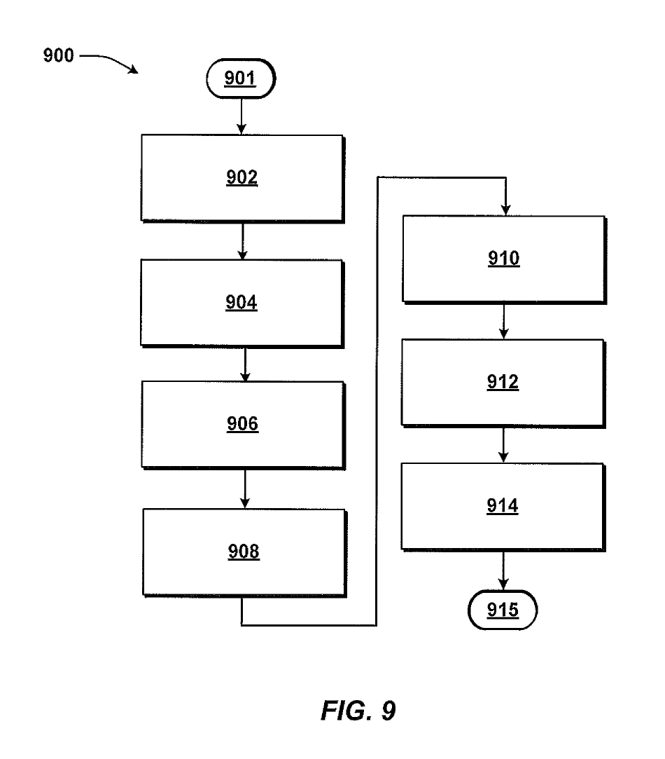

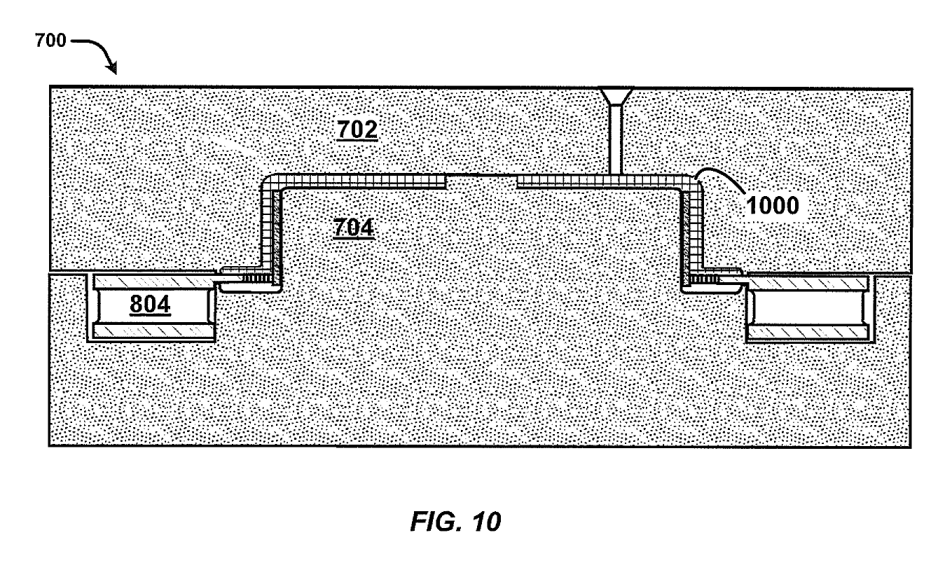

FIG. 8 shows a side cross-sectional view of another a rotor 800 according to another exemplary embodiment. In traditional rotors, a hat section includes a single material, such as aluminum or aluminum alloy. In the hat section of the present invention, the hat 802 includes at least one porous structure, which is not shown in detail in FIG. 8, but referenced by numeral 1000 in FIG. 10. As described in further detail below in connection with the method of FIG. 9, the porous structure 1000 can have any of a variety of configurations, including materials, sizes, and shapes.

For instance, the porous structure 1000 could be sized and shaped to cover all or a portion of a wheel stud area 806 of the hub 802 to which bolts are fastened to connect the disc brake rotor 800 to the wheel and the balance of the vehicle. The porous structure 1000 may be positioned, additionally or alternatively, in other parts of the hub 802. In the embodiment shown in FIG. 10, in connection with the method 900 of FIG. 9, the porous structure 1000 is illustrated as having generally the same shape and size (e.g., same thickness, etc.) as the resulting hub 802.

As shown in FIG. 8, the rotor 800 also includes a frictional disc 804, which may be similar or identical to the disc 502 described above. The rotor 800 of this embodiment can be made with or without the same porous structure 715 (i.e., the insert positioned in the cylindrical frictional surface) described above in connection with FIGS. 5-7. The rotor 800 of FIG. 8, including the porous structure 1000, may otherwise be the same as the rotor 500 of FIG. 5, including porous structure 715.

Second Exemplary Method for Forming Mixed-Material Brake Rotor

FIG. 9 schematically illustrates a method for forming the molded component 800 of FIG. 8, according to an embodiment of the present disclosure. The steps of the method 900 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the illustrated method 900 can be performed in parts, and so can be ended at any time.

The method 900 of FIG. 9 is described in connection with a mold 700 similar or identical to that described above in connection with FIG. 7. The method 900 begins 901 and flow proceeds to block 902, whereat the mold 700 is provided. As with the method 600 of FIG. 4, the mold 700 may be maintained within a controlled temperature range specific to the process used to achieve a proper state of thermal expansion of the mold 700. In some embodiments, the frictional disc 804 and porous structure 1000 are also brought to and kept at controlled temperatures to achieve a proper state of thermal expansion for the parts, and thereby ensuring proper fit of the parts in the mold 700.

At block 904, the frictional disc 804 and porous structure 1000 are introduced to the mold 700. As provided above for the mold 700 in connection with FIG. 7, the mold 700 has various features configured to properly align the frictional disc 804 and porous structure 1000 in the mold 700. Regarding positioning the porous structure 1000 in the mold, in one contemplated embodiment, the cylindrical porous insert slip fits over the male form 714 of the lower mold portion 704 to control its concentric position. In some cases, radial orientation is not a concern because it is the same material around the complete annular form.

In some cases, the porous structure 1000 includes feet, pads, or other extended or protruding base or segment (not shown in detail) sit on a surface of the mold 700 or other part, such as the male cylindrical surface 714 of the lower mold half 704 and/or the adjacent surface (of the flange 710), to suspend the porous structure 1000 at a proper height in the mold 700. In one contemplated embodiment, the structure 1000 and/or feet are sized to be larger than a height of the final void in the mold 700 (prior to introduction of filler material) so that closure of the mold 700 would crush the feet, bringing the porous structure 1000 to proper height.

Also, the porous structure 1000 is in some embodiments positioned in the mold 700 by ways including by chaplets or spacers, or by being suspended by tabs supported in the mold.

In one contemplated embodiment, the cylindrical male surface 714 of the mold, over which the insert 1000 is placed to register its axial position in the mold, has a height (or top) controlled by a length tolerance of the insert 1000.

In some embodiments, radial positioning is not a concern when there is no preference for radial position of the structure 1000 outside of the concentricity controlled by the raised center portion 712, 714 of the lower mold 704, corresponding to an axle center of the resulting rotor hat section.

At block 906, after the frictional disc 804 is positioned in the mold 700, the mold is closed. At block 908, with the mold 700 closed, fluid filler material, such as molten aluminum or aluminum alloy, is introduced to an interior of the mold for finalizing the disc 804 and matrix composite hat 802. Particularly, the filler material fills the cavity formed between the mold portions 702, 704, thereby coating the rotor disc 804 and the porous structure 1000. Due to the porosity of the porous structure, the filler material also impregnates the porous structure 1000, thereby forming the metal-matrix composite to be the hub 802.

Block 910 represents a period of solidification in which the molten or otherwise fluid material solidifies. Following solidification, at block 912 the mold is opened and the molded rotor 800 removed. At block 914, the rotor 800 is finished as desired. At block 915, the process may end, and may be repeated to produce another rotor 800. The method 900 may otherwise be identical to the method 600 of FIG. 6.

### Additional Embodiments and Representations

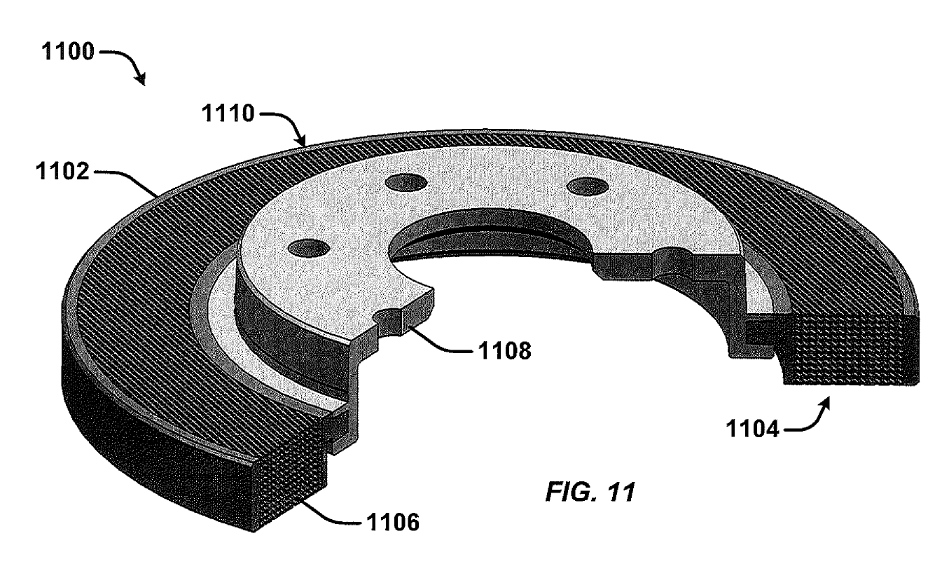

FIG. 11 illustrates another exemplary molded component 1100, being a brake rotor and including a non-vented disc 1102 having a mixed-material composite 1104.

The rotor 1100 may be produced according to a casting process similar to those described above regarding other embodiments. For the rotor 1100 of FIG. 11, though the porous structure 1106 forming the mixed-material composite 1106 is incorporated into the disc 1102 prior to the disc 1102 being introduced into a mold for combination with the hat 1108, such as by introduction of the completed disc 1102, including the composite 1104, into the mold 700 of FIG. 7 or 10, instead of the disc 502.

The mold for casting the disc 1102 for the rotor 1100 including the composite 1104 is not shown in detail, but it will be appreciated that the mold is sized and shaped for the disc 1102 and the process of casting can be generally the same as the processes described above in connection with the methods 600, 900 of FIGS. 6 and 9. The body material to be introduced to such mold, for surrounding and impregnating the porous structure 1106, to form the disc 1102 including composite 1104, may be any of those described above, including molten cast-iron.

In a contemplated embodiment, the porous structure 1106 is introduced to the mold 700 and impregnated with the same body material forming the hat 1108 of the rotor 1100 and in the same method step.

As shown in FIG. 11, the porous structure 1106 is sized, shaped, and included in an appropriate mold so that the resulting composite 1104 extends to a frictional surface 1110 of the disc 1102. The rotor 1100 may otherwise be configured and produced according to the configurations and methods described above regarding other embodiments of the present technology

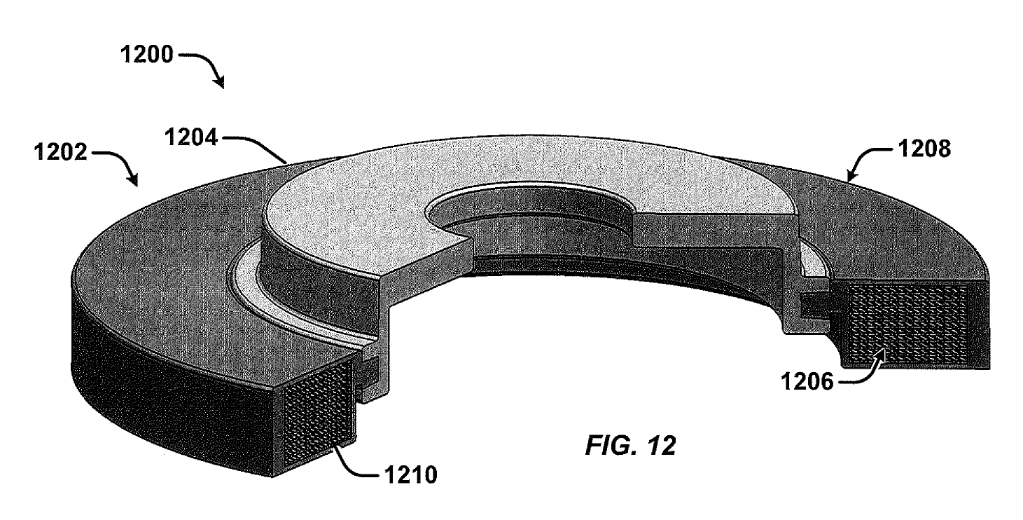

FIG. 12 illustrates another exemplary molded component 1200, being a brake rotor and including a frictional surface area 1202 of a non-vented disc 1204 having a mixed-material composite 1206 like the disc 1104 of FIG. 11, but without the composite 1206 reaching the frictional surface 1208 of the surface area 1202.

Accordingly, the porous structure 1210 for the rotor 1200 of FIG. 12 is sized, shaped, and included in an appropriate mold so that the resulting composite 1206 does not extend to the surface 1208 of the disc 1204. The rotor 1200 may otherwise be configured and produced according to the configurations and methods described above regarding other embodiments of the present technology

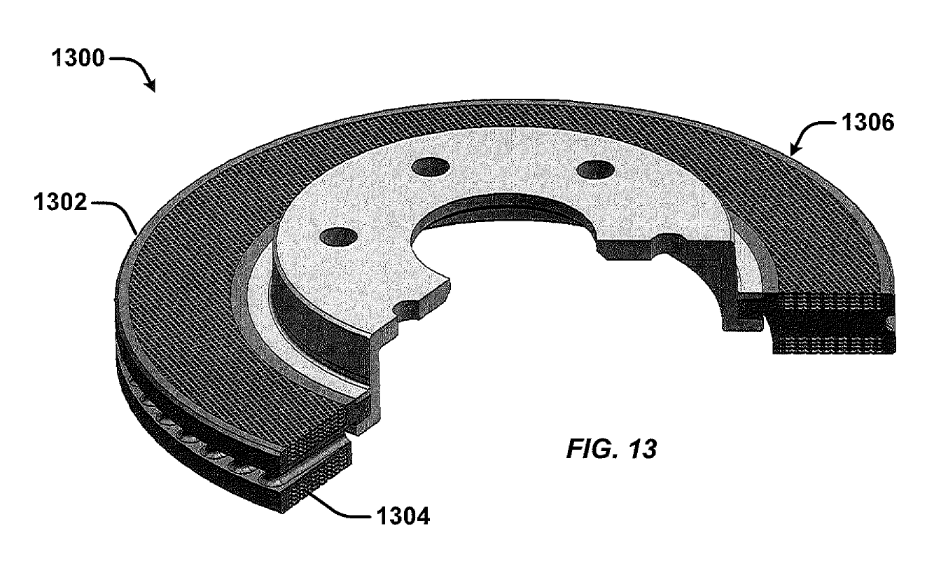

FIG. 13 illustrates another exemplary molded component 1300, being a brake rotor and including a vented disc 1302 having a mixed-material composite 1204 that reaches the frictional surface 1306 of the disc 1302. The rotor 1300 may be produced in generally the same manner described above with respect to the rotors 1100 and 1200 of FIGS. 11 and 12.

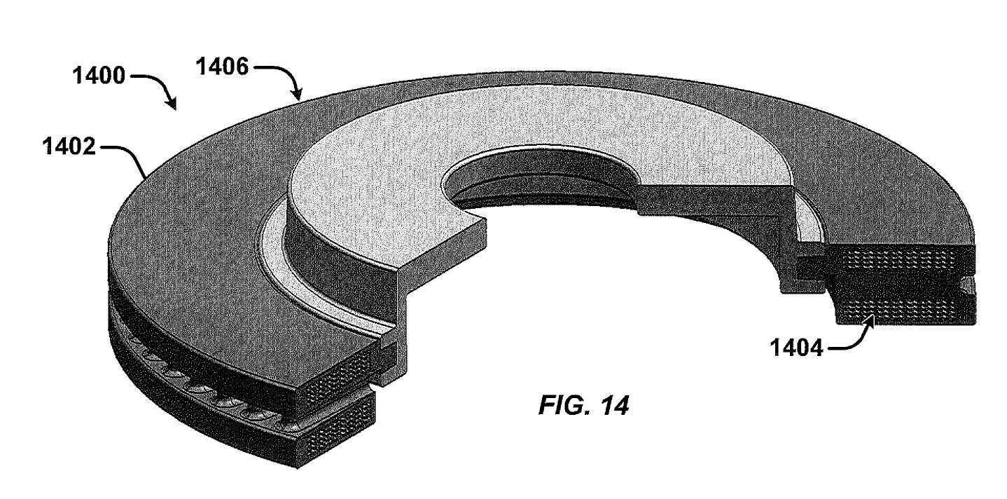

FIG. 14 illustrates another exemplary molded component 1400, being a brake rotor and including a vented disc 1402 having a mixed-material composite 1404 that does not reach the frictional surface 1406 of the disc 1402. The rotor 1400 may be produced in generally the same manner described above with respect to the rotor 1100 of FIG. 12.

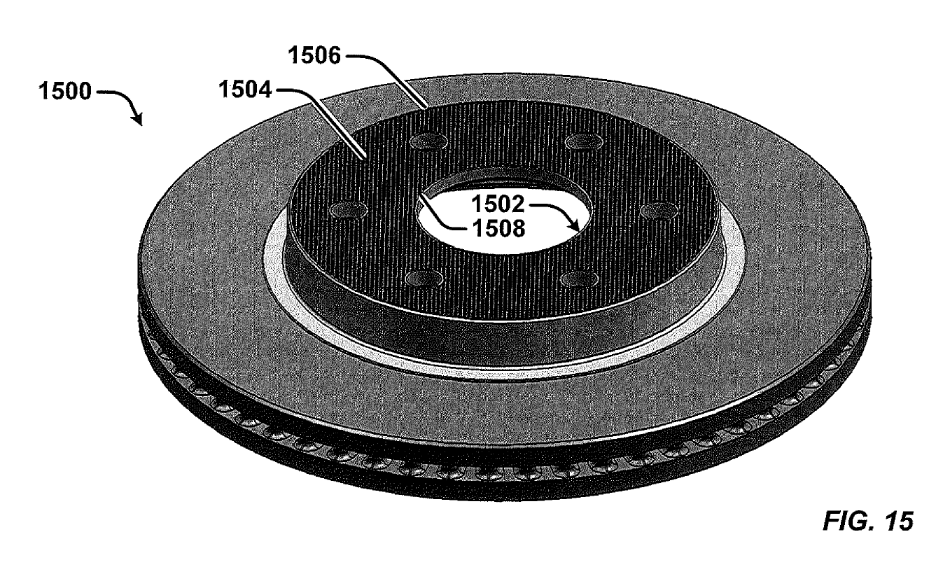

FIG. 15 illustrates another exemplary molded component 1500 similar to that described in connection with FIGS. 8-10, but showing only mixed-material composite 1502 in the bolt face area 1504 of the rotor hat 1506. The rotor 1500 of FIG. 15 may be configured and produced according to the configurations and methods described above regarding other embodiments of the present technology, and especially the embodiments described in connection with FIGS. 8-10.

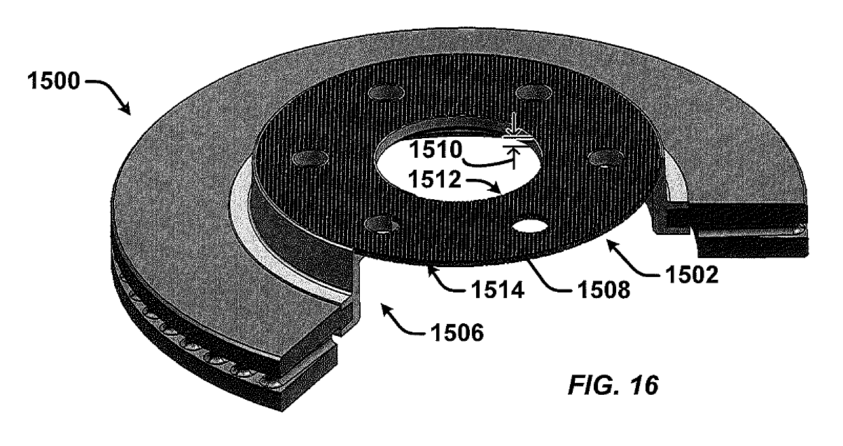

FIG. 16 illustrates a cross-sectional view of the rotor 1500 of FIG. 15. As shown, the porous structure 1508 to form the composite 1502 has a thickness 1510, which may be substantially equal to a resulting thickness 1510 (shown in FIG. 15) of the hat 1506 at the bolt face area 1504. As described above in connection with the rotor 800 in connection with FIGS. 8-10, the thickness 1510 of the rotor 1500 (e.g., at the area of the bolt face 1304) may vary slightly during processing to accommodate finish machining resulting in the thickness of the porous structure 1508 extending completely between a top surface 1512 (shown in FIG. 15) and a bottom surface 1514 (also shown in FIG. 15) of the hat 1506 at the bolt face area 1504. In a contemplated embodiment, the porous structure 1508 is sized, shaped, and positioned in a proper mold so that the resulting composite 1502 does not reach the top of the surface 1512.

### CONCLUSION

Various embodiments of the present disclosure are disclosed herein. The disclosed embodiments are merely examples that may be embodied in various and alternative forms, and combinations thereof.

The technologies described provide numerous performance and cost benefits associated with the manufacturing and use of molded components. The embodiments in which a design feature is formed via porous structure enable provision of components having the design feature, for identifying components. Additional exemplary benefits include reducing mass, and weight.

Particular to the examples related to brake rotors, rotors prepared to include the design feature have also been found to exhibit improved qualities, such as improved NVH (noise, vibration, wear, friction, and harshness) properties during operation, improved acoustic reflection, and improved energy absorption.

Regarding the metal-matrix composite as a braking surface or hat body component, the resulting surface or body exhibits high performance characteristics, such as increased strength, increased durability, and improved thermal properties as compared to an all-cast-iron hat and/or disc. Specific to frictional-surface applications, the resulting component in some cases exhibits less or at least acceptable wear, increased coefficient of friction (for frictional surfaces applications), and improvements in NVH.

Also, by the present technology increased component strength can be selectively focused on portion of the component, as desired via sizing, shaping, and positioning in the mold of the porous structure. For instance, the porous structure can be strategically added around the bolt holes of a rotor hat to strengthen the area at which the rotor connects to the vehicle wheel and vehicle axle, at the inner cylindrical frictional surface of the hat to strengthen the frictional surface, or at the frictional surface of the disc.

Rotors, or other components having a metal-matrix composite, or other mixed-material composite, are also cost-effective to manufacture and lighter. For instance, in one embodiment, the weight of the rotor, or even of just a part thereof (e.g., the hat), is reduced in some cases by as much as 50%-60%, or more, as compared to traditional rotors. The increased volume of larger parts, such as the hat of the rotor, allow use of more porous structure, thereby increasing the potential benefits, such as lower weight, without compromising strength.

The law does not require and it is economically prohibitive to illustrate and teach every possible embodiment of the present claims. Hence, the above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method for forming a brake rotor having a visible design feature, the method comprising:
positioning a porous structure in a casting mold, the porous structure defining a three-dimensional area; and
introducing molten metal into the casting mold so that the molten metal:
is introduced into the area of the porous structure for creating a design portion of the rotor; and
occupies the mold adjacent the porous structure for creating a primary portion of the rotor.

2. The method of claim 1, wherein positioning the porous structure in the casting mold includes positioning in the mold a structure selected from a group of structures consisting of:
a foam;
a fiber; and
a mesh.

3. The method of claim 1, wherein the porous structure includes a ceramic or a metal mesh.

4. The method of claim 1, wherein the primary portion resulting from performance of the method has a frictional surface to be contacted by a rotor pad in operation of the rotor and the design portion resulting from performance of the method has a design surface adjacent the frictional surface of the rotor body.

5. The method of claim 1, wherein
the porous structure positioned in the casting mold is a first porous structure resulting in a first design portion of the rotor;
the method further comprises positioning at least one other porous structure in the casting mold, the other porous structure defining another three-dimensional area; and
introducing molten metal into the casting mold causes molten metal to:
be introduced into the area of the other porous structure for creating a second design portion of the rotor; and
occupy the mold adjacent the first porous structure and the other porous structure for creating the primary portion of the rotor.

6. The method of claim 1, wherein positioning the porous structure in the casting mold includes securing the porous structure in a desired position in the mold by a mechanism selected from a group of mechanisms consisting of:
a chaplet;
a spacer;
a suspension tab; and
an extended segment of the porous structure.

7. The method of claim 1, wherein the porous structure is at least partially coated with a coating material.

8. The method of claim 7, further comprising at least partially coating the porous structure prior to positioning the porous structure in the casting mold.

9. A method for forming a brake rotor having a visible design feature, the method comprising:
positioning a porous structure in a casting mold, the porous structure defining a three-dimensional area; and
introducing molten metal into the casting mold so that the molten metal:
is introduced into the area of the porous structure for creating a mixed-material composite; and
occupies the mold adjacent the porous structure for creating other portions of the rotor.

10. The method of claim 9, wherein positioning the porous structure in the casting mold includes positioning in the mold a structure selected from a group of structures consisting of:
a foam;
a fiber; and
a mesh.

11. The method of claim 9, wherein the porous structure is at least partially coated with a coating material.

12. The method of claim 9, wherein positioning the porous structure in the casting mold includes positioning the structure in a portion of the mold corresponding to a cylindrical drum-in-hat frictional surface for forming the surface to include the mixed-material composite.

13. The method of claim 9, wherein positioning the porous structure in the casting mold includes positioning the structure in a portion of the mold corresponding to a rotor disc for forming the rotor disc to include the mixed-material composite.

14. The method of claim 9, wherein positioning the porous structure in the casting mold includes positioning the structure in a portion of the mold corresponding to a hat of the rotor for forming the hat to include the mixed-material composite.

15. The method of claim 9, wherein positioning the porous structure in the casting mold includes securing the porous structure in a desired position in the mold by a mechanism selected from a group of mechanisms consisting of:
a chaplet;
a spacer;
a suspension tab; and
an extended segment of the porous structure.
